(19) United States
(12) Patent Application Publication
(10) Pub. No.: US 2016/0200021 A1
(43) Pub. Date: Jul. 14, 2016

(54) COMPRESSION CONTROLLER OF INJECTION MOLDING MACHINE

(71) Applicant: FANUC Corporation, Yamanashi (JP)

(72) Inventor: Tatsuhiro UCHIYAMA, Yamanashi (JP)

(21) Appl. No.: 14/993,200

(22) Filed: Jan. 12, 2016

(30) Foreign Application Priority Data
Jan. 13, 2015 (JP) 2015-004362

(51) Int. Cl. B29C 45/80; B29C 45/77

(52) U.S. Cl. CPC B29C 45/80; B29C 45/77; B29L 2031/00

(57) ABSTRACT

In a compression controller of an injection molding machine, a movement command for a compression member at a sampling time immediately before the point in time when a compression operation start condition is established is output so that the amount of movement of the compression member is a movement amount obtained during a time interval between the point in time when the compression operation start condition is established and a sampling time immediately thereafter when it is determined that the compression operation start condition is established during a time interval between successive sampling times. Thus, delay-free compression operation can be performed without changing the sampling period.

### BACKGROUND OF THE INVENTION

1. Field of the Invention

The present invention relates to a compression controller of an injection molding machine.

2. Description of the Related Art

There is a compression molding method in which an ejector mechanism or a mold clamping mechanism of an injection molding machine is operated to compress an injected resin after or during injection. By this method, resulting molded articles can be improved in pressure-transferability or thin-walled. When a molten resin is injected into a mold, a pressure is applied in only one direction along a passage for the resin. In molding a disk-like molded article, therefore, the pressure is applied radially so that radial lines may be formed on the molded article in some cases. Since the pressure can be applied to the injected resin by compression molding, the direction of the pressure on the resin is uniform.

In the compression molding, a compression member is moved to compress the resin in the mold. The compression member used may be the ejector mechanism, the mold clamping mechanism, or a core in the mold used when the molded article is hollow or tubular.

Japanese Patent Application Laid-Open No. 7-137107 discloses a compression molding method in which a molded article is molded by applying a pressing force to a resin in a mold of an injection molding machine using ejector means for ejecting the molded article from the mold.

Japanese Patent Application Laid-Open No. 9-174633 discloses a technique in which a servomotor for compression is used to drive a clamp axis or an ejector axis to compress a resin in a mold.

Japanese Patent Application Laid-Open No. 60-179216 discloses a technique in which a resin in a mold is compressed by means of a cavity plate in the mold.

Japanese Patent Application Laid-Open No. 7-68613 discloses a technique in which a mold clamping motor for clamping a mold is rotated by a predetermined amount so that a movable platen and a movable mold can be moved by a predetermined distance by a toggle mechanism or the like to apply a compressive force to a molten resin in a mold cavity.

A technique for correcting movement commands for a screw in an injection process is disclosed in Japanese Patent Applications Laid-Open Nos. 8-323824 and 2006-272646.

In the compression molding, a compression operation is performed while the resin injected into the mold is gradually solidifying. If the timing of the start of compression varies, therefore, the fluidity of the resin changes even though the compression stroke is fixed, so that the shape and dimensional accuracy of the finished molded article may vary.

Although the compression molding technique is disclosed in Japanese Patent Applications Laid-Open Nos. 7-137107 and 9-174633, the timing of the start of compression is not.

According to Japanese Patent Applications Laid-Open Nos. 60-179216 and 7-68613, the timing of the start of compression is set in consideration of the molten state of the resin in the mold. Therefore, conditions for the start of compression operation are set based on timings when a predetermined time is reached by the elapsed time since the start of injection, when a predetermined value is reached by the resin pressure, or when a predetermined position is reached by the resin. In a compression process of these techniques, the compression operation is started when a controller, which monitors the time and pressure detected by a timer and a pressure sensor therein, detects that a predetermined time or pressure is reached.

In general, a controller for controlling a machine tool or industrial machinery is configured to perform signal input/output, logical operation, or the like at a predetermined sampling time determined according to the throughput of a CPU (central processing unit) in the controller. A controller of an injection molding machine also monitors the timer or resin pressure for each sampling time thereof in controlling a compression operation. The compression operation is also started for each sampling time. If the sampling period is long, therefore, the monitoring interval for the timer and resin pressure is also long, so that the start of compression and the compression operation thereafter may possibly be delayed relative to a preset operating time.

Although the technique for correcting the movement commands for the screw in the injection process is disclosed Japanese Patent Applications Laid-Open Nos. 8-323824 and 2006-272646, the compression start timing for compression operation is not. In a molding operation such as compression molding in which an operation delay of a compression member affects the quality of molded articles, therefore, it is difficult to correct the operation of the compression member.

### SUMMARY OF THE INVENTION

Accordingly, the object of the present invention is to provide a compression controller of an injection molding machine, which enables delay-free compression operation in the injection molding machine.

In a compression controller of an injection molding machine according to the present invention, which outputs a movement command for compressing a resin in a mold to a compression member of the injection molding machine for each predetermined sampling period, based on a preset compression completion position and a set speed, the compression controller comprises compression operation start condition setting means for setting a compression operation start condition of the compression member, establishment determination means for determining whether or not the compression operation start condition set by the compression operation start condition setting means is established during a time interval between successive sampling times, and movement amount calculation means for obtaining, as a calculated movement amount, the amount of movement of the compression member during a time interval between the point in time when the compression operation start condition is established and a sampling time immediately thereafter when it is determined that the compression operation start condition is established during the time interval between the successive sampling times. The movement command for the compression member at the sampling time immediately before the point in time when the compression operation start condition is established is output so that the amount of movement is equal to the calculated movement amount obtained by the movement amount calculation means.

Thus, in the compression controller of the injection molding machine, delay-free compression operation can be performed without reducing the sampling period by speeding-up of a CPU or the like.

The compression operation start condition may be a condition that the elapsed time since the start of injection exceeds a preset compression start time.

The compression operation start condition may be a condition that the pressure of the resin exceeds a preset resin pressure.

The compression operation start condition may be a condition that the position of a screw exceeds a preset screw position.

The compression operation start condition may be a condition that a detected value affecting a process of solidification of the resin in the mold exceeds a predetermined value.

Thus, the delay-free compression operation can be performed without changing the sampling period. The speed of the screw or the temperature of the, resin may be given as an example of the detected value affecting the process of solidification of the resin in the mold.

According to the present invention, there can be provided a compression controller of an injection molding machine, which enables delay-free compression operation in the injection molding machine.

### BRIEF DESCRIPTION OF THE DRAWINGS

The above and other objects and features of the present invention will be obvious from the ensuing description of embodiments with reference to the accompanying drawings, in which:

FIG. 1 is a configuration diagram of a conventional injection molding machine;

FIG. 2A is a diagram showing an ideal compression start time and a prior art compression start time for a compression operation of the injection molding machine;

FIG. 2B shows an ideal movement command for a compression member;

FIG. 2C shows a prior art movement command for the compression member;

FIG. 3 is a flowchart showing processing for outputting a movement command for each sampling period in the controller according to an embodiment of the present invention;

FIG. 4A is a diagram showing the relationship between a compression start time according to a first embodiment and the ideal compression start time;

FIG. 4B shows the ideal movement command for the compression member;

FIG. 4C shows the prior art movement command for the compression member;

FIG. 5A is a diagram showing how a resin pressure according to a second embodiment changes;

FIG. 5B is a diagram showing the relationship between a compression start time according to the second embodiment and the ideal compression start time;

FIG. 6A is a diagram showing how a screw position according to a third embodiment changes; and

FIG. 6B is a diagram showing the relationship between a compression start time according to the third embodiment and the ideal compression start time.

### DETAILED DESCRIPTION OF THE PREFERRED EMBODIMENTS

### First Embodiment

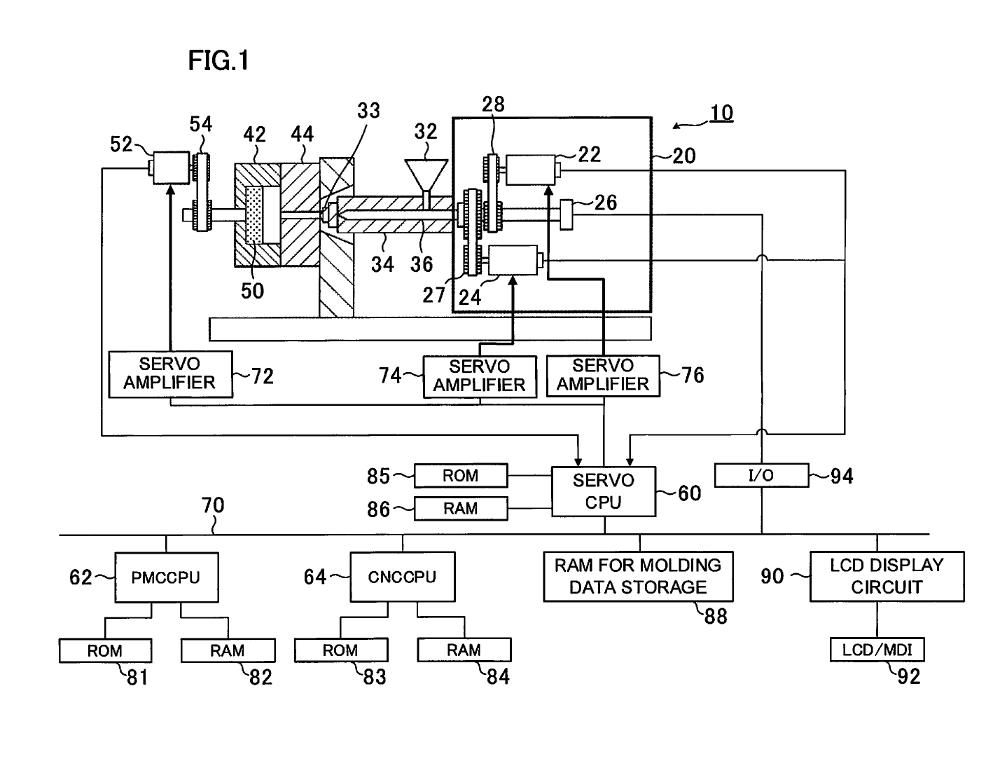

An embodiment of the present invention will now be described with reference to the accompanying drawings. FIG. 1 is a configuration diagram of a conventional injection molding machine. The injection molding machine generally comprises an injection device and a mold clamping device that are disposed on a machine base. FIG. 1 mainly shows an injection unit 10, which is equivalent to the injection device, and a controller for generally controlling a movable mold 42, a fixed mold 44, a compression member, and the injection unit 10.

In the injection unit 10, a nozzle 33 is attached to the distal end of a cylinder 34 into which a screw 36 is inserted, and a hopper 32 is mounted near the rear end of the cylinder 34. The hopper 32 supplies resin pellets to the cylinder 34. Further, the injection unit 10 comprises an injection motor 22, as drive means for axially driving the screw 36, a transmission mechanism 28, and the like. The screw 36 is axially driven for injection control by the injection motor 22, the transmission mechanism 28, and the like. Furthermore, the injection unit 10 comprises a motor 24 for screw rotation, as rotary drive means for rotating the screw 36, and a transmission mechanism 27 comprising a belt, pulleys, and the like. The screw 36 is driven to rotate by the motor 24 for screw rotation and the transmission mechanism 27 including the belt, pulleys, and the like.

The injection motor 22 and the motor 24 for screw rotation are individually fitted with position/speed sensors (not shown) for detecting their rotational positions and speeds. The position/speed sensors can detect the position (along the screw axis) of the screw 36, moving speed (injection speed), and rotational speed of the screw 36. Further, the screw 36 is provided with a resin pressure sensor 26 for detecting a force applied from the molten resin to the screw 36 along the screw axis.

As the screw 36 in the cylinder 34 is driven, the molten resin is injected and fed into the movable mold 42. A compression member 50 is disposed in the movable mold 42 and it can be moved back and forth by a transmission mechanism 54 comprising a belt, pulleys, and the like.

A PMC-CPU 62 is connected with a ROM 81, which is stored with sequential programs for controlling the sequential operation of the injection molding machine. The PMC-CPU 62 is also connected with a RAM 82 used for temporary storage of arithmetic data and the like. A CNC-CPU 64 is connected with a ROM 83, which is stored with automatic operation programs for generally controlling the injection molding machine. The CNC-CPU 64 is also connected with a RAM 84 used for temporary storage of arithmetic data and the like.

A servo CPU 60 is connected with a ROM 85, which is loaded with a dedicated control program for servo control for position, speed, and current loop processing. The servo CPU 60 is also connected with a RAM 86 used for temporary storage of data. Further, the servo CPU 60 is connected with a servo amplifier 76, which drives the injection motor 22 based on a command from the servo CPU 60, a servo amplifier 74 configured to drive the motor 24 for screw rotation, and a servo amplifier 72 configured to drive a motor 52 for compression operation.

The injection motor 22, motor 24 for screw rotation, and motor 52 for compression operation are individually fitted with position/speed detectors (not shown). Outputs from these position/speed detectors are fed back to the servo CPU 60. The servo CPU 60 performs position and speed feedback control, based on a movement command for each axis X (injection motor 22 or motor 24 for screw rotation) issued from the CNC-CPU 64 and detected positions and speeds fed back from the position/speed detectors. The servo CPU 60 also performs current feedback control, thereby drivingly controlling the servo amplifier 76 for driving the injection motor 22, the servo amplifier 74 for driving the motor 24 for screw rotation, and the servo amplifier 72 for driving the motor 52 for compression operation.

An LCD/MDI (input device with display) 92 with a display unit is connected to a bus 70 through an LCD display circuit 90. A RAM 88 for molding data storage, which is formed of a nonvolatile memory, is also connected to the bus 70. The RAM 88 for molding data storage is stored with molding conditions, various set values, parameters, macro variables, and the like, related to an injection molding operation.

With the configuration described above, the PMC-CPU 62 controls the sequential operation of the entire injection molding machine. Based on operation programs of the ROM 83, the molding conditions stored in the molding data storage RAM 84, and the like, the CNC-CPU 64 outputs a movement command to the servo CPU 60 for each sampling time. Based on the movement command, the servo CPU 60 outputs current commands to the servo amplifiers 76, 74 and 72 for driving the injection motor 22, motor 24 for screw rotation, and motor 52 for compression operation, respectively. Based on position and speed feedback signals detected by the position/speed detectors (not shown), and the like, moreover, the servo CPU 60 performs servo controls, that is, position, speed, and current loop controls. These controls are called digital servo processing.

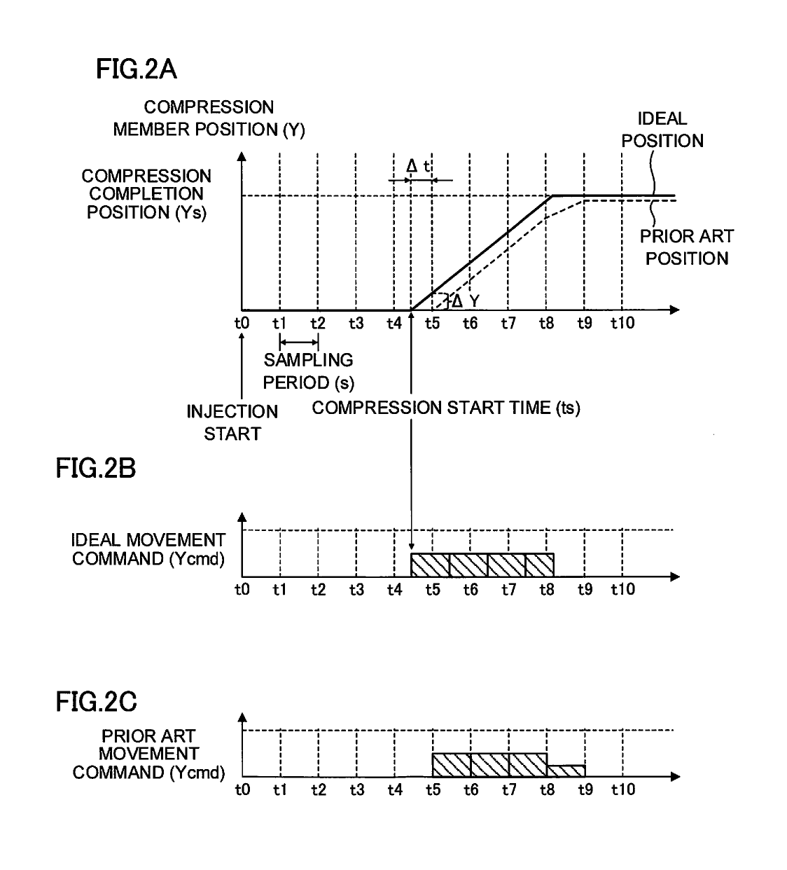

FIG. 2A shows an ideal compression start time and a prior art compression start time for the compression operation of the injection molding machine. The elapsed time since the start of injection is set as a compression start time ts. Ideally, therefore, the compression operation is started just at a point in time when the time ts has elapsed since the start of the injection and is continued until a compression completion position (Ys) is reached. FIG. 2B shows a movement command for the compression member for that case.

However, the movement command is output only for each sampling time of the CNC-CPU 64. If the compression start time (ts) is set so that the elapsed time since the start of the injection is not equal to an integral multiple of a sampling period, therefore, the compression operation of the compression member cannot be started at the ideal compression start time. The compression operation of the compression member is inevitably performed at the sampling time immediately after the ideal compression start time, and compression is started at a timing t5. This case is indicated by a dotted line in FIG. 2A, and FIG. 2C shows a movement command for the compression member for that case.

Since the actual compression start time is t5, the operation is always delayed during a period elapsed from the start of the compression until the compression position is reached by the compression member. The delay time is a period of time elapsed from the ideal compression start time (ts) until the sampling time t5 immediately thereafter.

Also during the delay time, solidification of the resin progresses in the mold. Although the compression by the compression member is performed to achieve the movement to the compression completion position, therefore, a proper molded article may possibly fail to be molded.

In order to reduce the time elapsed from the ideal compression start time until the sampling time immediately thereafter, the sampling period can be reduced by speeding up the CNC-CPU 64 of the controller of the injection molding machine. However, the speeding-up of the CPU makes the controller expensive, and there is a limit of CPU speeding-up.

Accordingly, the present invention is intended to achieve delay-free compression operation without speeding up a CPU.

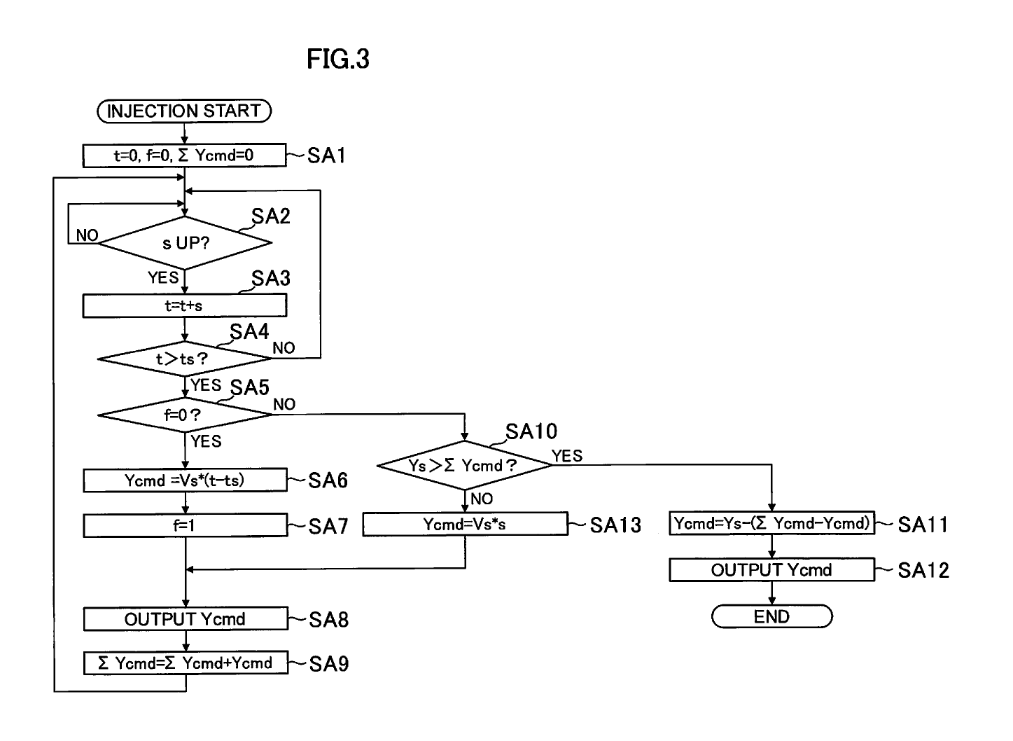

FIG. 3 is a flowchart showing processing for outputting a movement command (Ycmd) for each sampling period in the CNC-CPU 64 of the present embodiment. Compression operation start conditions are set in advance in the RAM 88. These conditions include the time elapsed from the start of the injection until the compression operation is started, that is, the ideal compression start time (ts), the compression completion position (Ys), and a set speed (Vs) of the compression member. In the description to follow, Ys may sometimes be used as the amount of movement of the compression member since the start of the compression.

The following is a sequential description of various steps of the processing.

(Step SA1) An elapsed time t from the start of the compression, flag f, and integrated value ΣYcmd of movement commands for the compression member are all initialized to 0.

(Step SA2) It is determined whether or not a sampling period s is up. If the sampling period s is up (YES), the processing proceeds to Step SA3. If not (NO), Step SA2 is repeated so that the sampling period s is up.

(Step SA3) The sampling period s is added to the elapsed time t from the start of the compression.

(Step SA4) It is determined whether or not the ideal compression start time ts is exceeded by the elapsed time t. If the ideal compression start time ts is exceeded (YES), the processing proceeds to Step SA5.

If not (NO), that is, if the ideal compression start time ts is equal to or not exceeded by the elapsed time t, the processing returns to Step SA2.

(Step SA5) It is determined whether or not the flag f is 0. If the flag f is 0 (YES), the processing proceeds to Step SA6. If not (NO), the processing proceeds to Step SA10.

(Step SA6) The amount of the movement command (Ycmd) is calculated as the product of the set speed (Vs) of the compression member and a period obtained by subtracting the ideal compression start time (ts) from the elapsed time t.

(Step SA7) The flag f is set to 1.

(Step SA8) The movement command (Ycmd) is output.

(Step SA9) The integrated value ΣYcmd of the movement commands for the compression member is updated by addition of the movement command (Ycmd) thereto, whereupon the processing returns to Step SA2.

(Step SA10) It is determined whether or not the amount of movement in the compression completion position (Ys) is exceeded by the integrated value EYcmd of the movement commands for the compression member. If the amount of movement is not exceeded (NO), the processing proceeds to Step SA13. If the amount of movement is exceeded (YES), the processing proceeds to Step SA11.

(Step SA11) The movement command (Ycmd) is calculated as a difference obtained by subtracting the difference between the integrated value ΣYcmd of the movement commands for the compression member and the movement command (Ycmd) from the amount of movement in the compression completion position (Ys).

(Step SA12) The movement command (Ycmd) is output, whereupon the processing ends.

(Step SA13) The movement command (Ycmd) is calculated as the product of the set speed (Vs) of the compression member and the sampling period s.

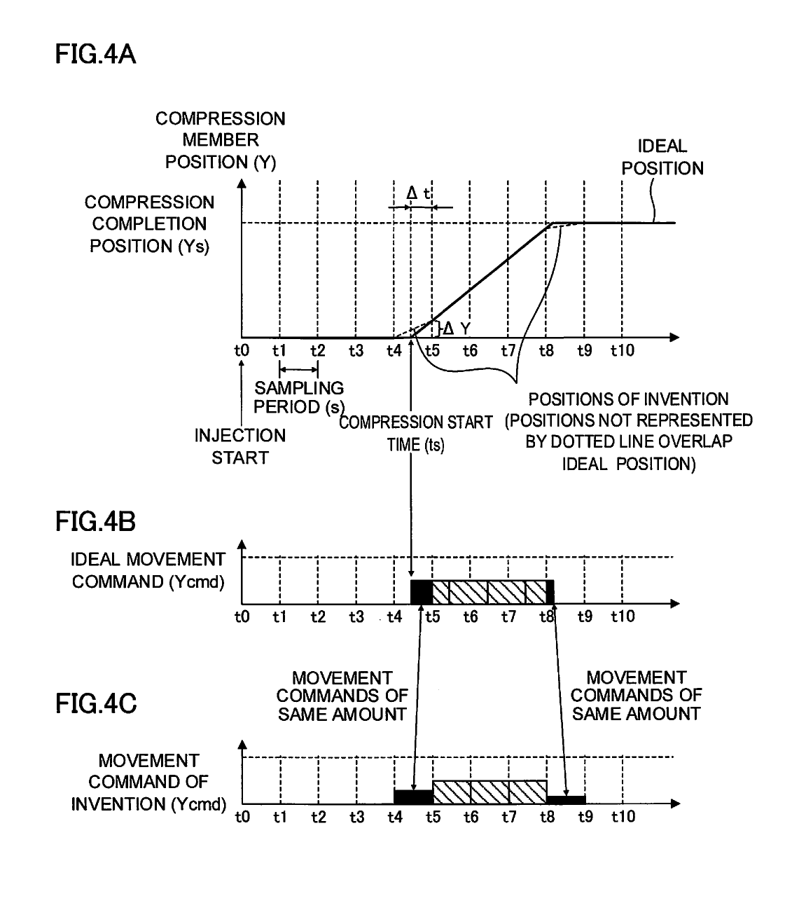

FIG. 4A is a diagram showing the ideal compression start time for the compression operation of the injection molding machine and the compression start time according to the present invention. An ideal movement of the compression member indicated by a full line resembles that of the example shown in FIG. 2A.

In the present embodiment, if the ideal compression start time (ts) is located between sampling times t4 and t5, for example, the movement command is output at the sampling time t4. As this is done, the compression is started at the sampling time t4 so that the amount of movement from the sampling time t4 to the sampling time t5 is equal to the amount of movement from the ideal compression start time (ts) to the sampling time t5 at the set speed (Vs) of the compression member. FIGS. 4A and 4C show how this is done. As indicated by a dotted line in FIG. 4A, the compression is started at the sampling time t4 so that an ideal position of the compression member is reached at the sampling time t5.

By this setting, filled areas between the sampling times t4 and t5 are made equal, as shown in FIGS. 4B and 4C. This indicates that the respective amounts of an ideal movement command and the movement command according to the present embodiment are equal in the interval between the sampling times t4 and t5.

This also applies to the case of a position just short of the compression completion position of the compression member. In the ideal movement, as shown in

FIG. 4A, the compression is completed between the sampling times t8 and t9. In this way, the amount of movement from the sampling time t8 to the sampling time t9 is made equal to the amount of movement from the sampling time t8 to an ideal compression completion time at the set speed (Vs) of the compression member.

Thus, the compression operation is started before the elapsed time t since the start of the injection exceeds the preset compression start time ts, so that it can be performed without delay relative to an ideal operation of the compression member.

### Second Embodiment

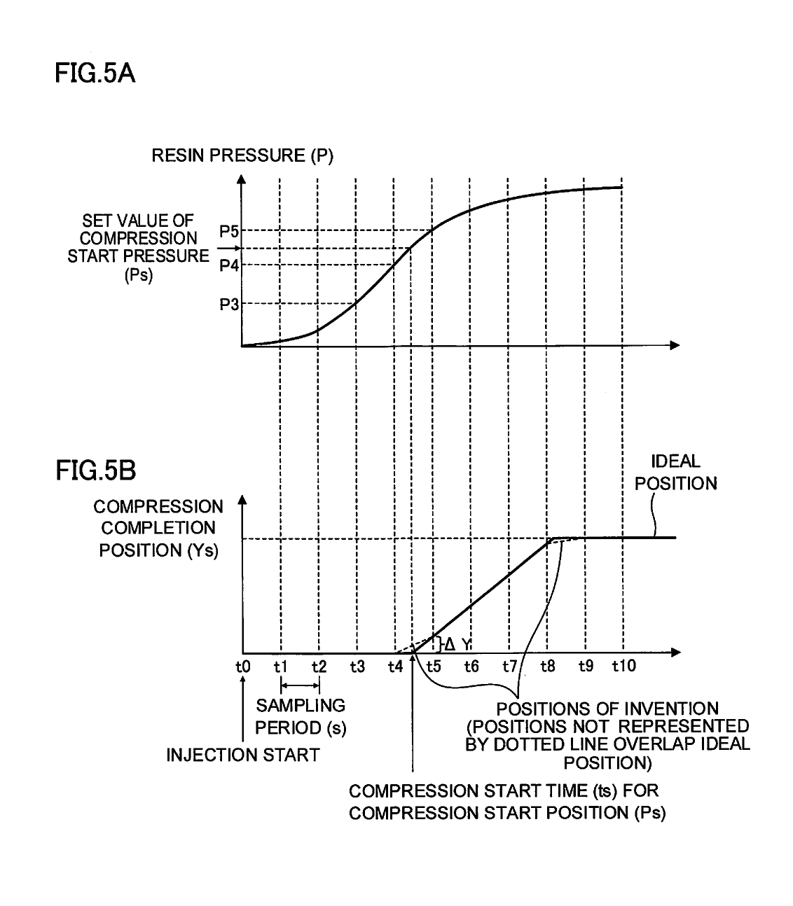

FIG. 5A is a diagram showing how a resin pressure changes. Further, FIG. 5B is a diagram showing an ideal compression start time for the compression operation of the injection molding machine and a compression start time according to the present embodiment. The present embodiment differs from the foregoing embodiment in that a compression operation start condition is that a predetermined compression start pressure (Ps) is exceeded by the resin pressure. The resin pressure can be detected by using a pressure sensor attached to the rear end of the screw 36 of the injection molding machine, such as the resin pressure sensor 26 shown in FIG. 1. The pressure sensor is not limited to this location and may alternatively be mounted on the nozzle 33 or in the molds 42 and 44.

As shown in FIG. 5B, an injection time since the start of injection corresponding to the compression start pressure (Ps) according to the present embodiment is intermediate between sampling times t4 and t5. When the injection is started, a controller detects the resin pressure for each sampling period. Based on the amount of change of the pressure, moreover, it is determined whether or not the detected resin pressure exceeds the predetermined compression start pressure (Ps) in the interval between current and next sampling periods. For example, a resin pressure (P5) at the sampling time t5 is predicted by equation (1) at the time t4 so that the pressures P5 and Ps can be compared for determination, as follows:

P5=(P4—P3)+P4. (1)

The time elapsed from the start of the injection until the compression start pressure (Ps) is reached, that is, a compression start time (ts), is obtained by equation (2) as follows:

ts=t4+S·(Ps−P4)/(P5−P4). (2)

In the case where the time for the start of compression is the point in time when the predetermined compression start pressure (Ps) is reached by the resin pressure, a movement command at the sampling time is output to move a compression member in the same manner as in the first embodiment after the compression start time (ts) is obtained according to equation (2).

### Third Embodiment

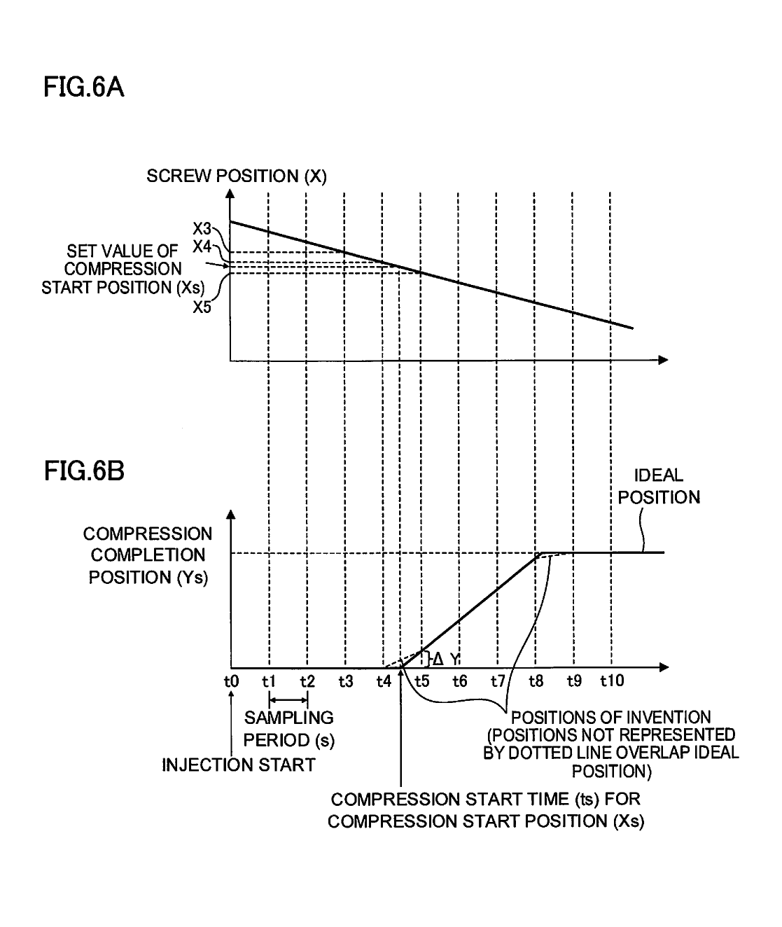

FIG. 6A is a diagram showing how a screw position changes. FIG. 6B is a diagram showing the ideal compression start time for the compression operation of the injection molding machine and a compression start time according to the present embodiment. The present embodiment differs from the foregoing embodiments in that a compression operation start condition is that a screw for injection is advanced to a predetermined position (Xs). When the injection is started, a controller detects the screw position for each sampling period. Based on the amount of change of the screw position, moreover, it is determined whether or not the detected screw position exceeds the set screw position (Xs) in the interval between current and next sampling periods. For example, a screw position (X5) at the sampling time t5 is predicted by equation (3) at the time t4 so that the positions X5 and Xs can be compared for determination, as follows:

X5=X4−(X3−X4). (3)

Further, the time elapsed from the start of the injection until the screw position (Xs) is reached, that is, a compression start time (ts), is obtained by equation (4) as follows:

ts=t4+S·(Xs−X4)/(X5−X4). (4)

In the case where the time for the start of compression is the point in time when the screw for injection is advanced to the predetermined position (Xs), a movement command at the sampling time is output to move a compression member in the same manner as in the first embodiment after the compression start time (ts) is obtained according to equation (4).

In the above description, the elapsed time since the start of injection, resin pressure, and screw position are given as the compression operation start conditions. However, the compression operation start conditions according to the present invention are not limited to those start conditions. Any of those detected values, such as the screw speed and resin temperature, which affect the process of solidification of the resin in the mold may be used as a compression operation start condition. In any case, as in the second and third embodiments, the movement command at the sampling time can be output to move the compression member in the same manner as in the first embodiment after the compression start time (ts) is obtained by comparison between each detected value and its corresponding predetermined reference value.

1. A compression controller of an injection molding machine, which outputs a movement command for compressing a resin in a mold to a compression member of the injection molding machine for each predetermined sampling period, based on a preset compression completion position and a set speed, the compression controller comprising:
compression operation start condition setting means for setting a compression operation start condition of the compression member;
establishment determination means for determining whether or not the compression operation start condition set by the compression operation start condition setting means is established during a time interval between successive sampling times; and
movement amount calculation means for obtaining, as a calculated movement amount, the amount of movement of the compression member during a time interval between the point in time when the compression operation start condition is established and a sampling time immediately thereafter when it is determined that the compression operation start condition is established during the time interval between the successive sampling times,
wherein the movement command for the compression member at the sampling time immediately before the point in time when the compression operation start condition is established is output so that the amount of movement is equal to the calculated movement amount obtained by the movement amount calculation means.

2. The compression controller of an injection molding machine according to claim 1, wherein the compression operation start condition is a condition that the elapsed time since the start of injection exceeds a preset compression start time.

3. The compression controller of an injection molding machine according to claim 1, wherein the compression operation start condition is a condition that the pressure of the resin exceeds a preset resin pressure.

4. The compression controller of an injection molding machine according to claim 1, wherein the compression operation start condition is a condition that the position of a screw exceeds a preset screw position.

5. The compression controller of an injection molding machine according to claim 1, wherein the compression operation start condition is a condition that a detected value affecting a process of solidification of the resin in the mold exceeds a predetermined value.
